(19) United States
(12) Patent Application Publication
(10) Pub. No.: US 2020/0164497 A1
(43) Pub. Date: May 28, 2020

(54) COMBINED BENT HANDLE RATCHET WRENCH

(71) Applicant: Kuei-Chuan CHANG, Taichung (TW)

(72) Inventor: Kuei-Chuan CHANG, Taichung (TW)

(21) Appl. No.: 16/203,099

(22) Filed: Nov. 28, 2018

(51) Int. Cl. B25B 23/16; B25B 13/46; B25G 1/10

(52) U.S. Cl. CPC B25B 23/16; B25G 1/102; B25B 13/463

(57) ABSTRACT

A combined bent handle ratchet wrench includes a main body made of plastic material, and the main body has its topside and its underside respectively covered with a first cover plate and a second cover plate, which are made of rigid materials. Thus, compared with the conventional forged combined ratchet wrench, the combined bent handle ratchet wrench is able to greatly reduce difficulty and cost in production. Further, the main body is provided therein with a positioning seat made of rigid material for carrying a ratchet actuating unit, and the positioning seat has two opposite sides respectively positioned at the first cover plate and the second cove plate and thus, the ratchet actuating unit can bear greater torsion.

### BACKGROUND OF THE INVENTION

### 1. Field of the Invention

This invention relates to a hand tool, particularly to a combined bent handle ratchet wrench.

### 2. Description of the Prior Art

A conventional ratchet wrench generally has a main body forging molded first, and then makes use of CNC to have the main body processing an accommodating groove for receiving a ratchet actuating unit therein, but such a way is difficult in processing and high in cost; therefore, a combined ratchet wrench is proposed and developed. The conventional combined ratchet wrench is formed with a plastic main body, which has one side provided with an accommodating groove for receiving a ratchet actuating unit, and the accommodating groove is covered with a cover body for restrictedly positioning the ratchet actuating unit in the main body, thus able to achieve the objective of facilitating production and assembly and lowering cost.

However, the conventional combined ratchet wrench is to have the ratchet actuating unit directly received in the plastic main body whose plastic structure is weak; therefore, it will greatly reduce the upper limit of torsion that the ratchet actuating unit can bear and further, presently, all the conventional combined ratchet wrench are level designed, that is, the head and the handle of the conventional combined ratchet wrench are at the same level, thus inconvenient in use and operation.

### SUMMARY OF THE INVENTION

The objective of this invention is to offer a combined bent handle ratchet wrench, which can greatly reduce production cost and can bear greater torsion.

The combined bent handle ratchet wrench in the present invention includes a main body, a first cover plate, a second cover plate, a positioning seat and a ratchet actuating unit. The main body is made of plastic material and formed with a head having one side bent up-ward and extended to form a neck, which is parallel to the head and extended to form a handle, letting a difference of height formed between the head and the handle. The head of the main body has its topside bored with a first accommodating groove and a second accommodating groove. The second accommodating groove is positioned between the first accommodating groove and the neck, and a communicating port is provided between the first accommodating groove and the second accommodating groove, letting the first accommodating groove and the second accommodating groove communicate with each other. The first cover plate made of rigid material is covered on the topside of the main body and covers the head, the neck and the handle. The first cover plate is bored with a first pivotal hole and a first operating hole corresponding to the first accommodating groove and has one inner side provided with a first positioning groove corresponding to the second accommodating groove. The second cover plate made of rigid material is covered on the underside of the main body and covers the head, the neck and the handle. The second cover plate is bored with a second pivotal hole corresponding with the first pivotal hole and provided with a second operating hole corresponding with the first operating hole and further, the second cover plate has one inner side bored with a second operating groove corresponding to the first operating groove. The positioning seat made of rigid material is received in the second accommodating groove and has opposite two sides respectively formed with a first positioning block and a second positioning block. The first positioning block is positioned in the first positioning groove, while the second positioning block is positioned in the second positioning groove and in addition, the positioning seat is symmetrically provide with two pivotal notches at one side facing the communicating port. The ratchet actuating unit is formed with a ratchet member received in the first accommodating groove, and the ratchet member has two ends respectively and rotatably inserted in the first pivotal hole and the second pivotal hole to enable the ratchet member to rotate in the first accommodating groove. Further, the ratchet actuating unit contains two engage blocks mounted between the ratchet member and the positioning seat and the two engage blocks have one end rotatably received in the pivotal notches and another end engaged with the ratchet member. The ratchet actuating unit further has two elastic members respectively disposed between the engage blocks and the inner wall of the first accommodating groove and contains an operating member formed with a shank, which is inserted between the two engage blocks and has one end inserted out of the first operating hole and formed with a turning button and has another end restrictedly positioned in the second operating hole.

When the combined bent handle ratchet member of this invention is to be produced and assembled, engineering plastics, which is easy to be molded, can be employed for producing the main body and next, the first cover plate and the second cover plate can be produced by simply bending two iron plates and then have the main body firmly sandwiched between the first cover plate and the second cover plate. Thus, compared with the conventional forged way, the combined bent handle ratchet wrench of this invention is able to greatly reduce difficulty in production and cost of production. In addition, since the positioning seat has its first positioning block positioned in the first positioning groove of the first cover plate and has its second positioning block positioned in the second positioning groove of the second cover plate, and the positioning seat, the first cover plate and the second cover plate are made of rigid material; therefore, the combined bent handle ratchet wrench of this invention can greatly reinforce its structural strength and enable the ratchet actuating unit to bear greater torsion, able to ameliorate the defect of the conventional combined ratchet wrench that is insufficient in torsion. Moreover, the difference of height exists between the head and the handle due to the bent neck; therefore, the combined bent handle ratchet wrench is convenient in grasping and operating.

### BRIEF DESCRIPTION OF DRAWINGS

This invention will be better understood by referring to the accompanying drawings, wherein:

FIG. 1 is a perspective view of a combined bent handle ratchet wrench in the present invention;

FIG. 2 is an exploded perspective view of the combined bent handle ratchet wrench in the present invention;

FIG. 3 is a vertically directional cross-sectional view of the combined bent handle ratchet wrench in the present invention; and

FIG. 4 is a horizontally directional cross-sectional view of the combined bent handle ratchet wrench in the present invention.

### DETAILED DESCRIPTION OF THE PREFERRED EMBODIMENT

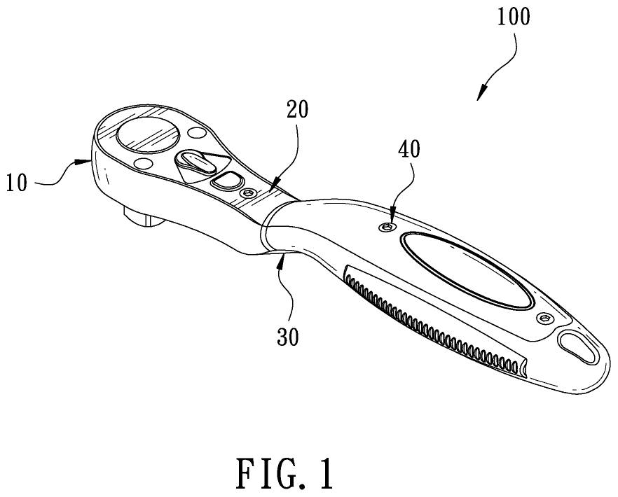

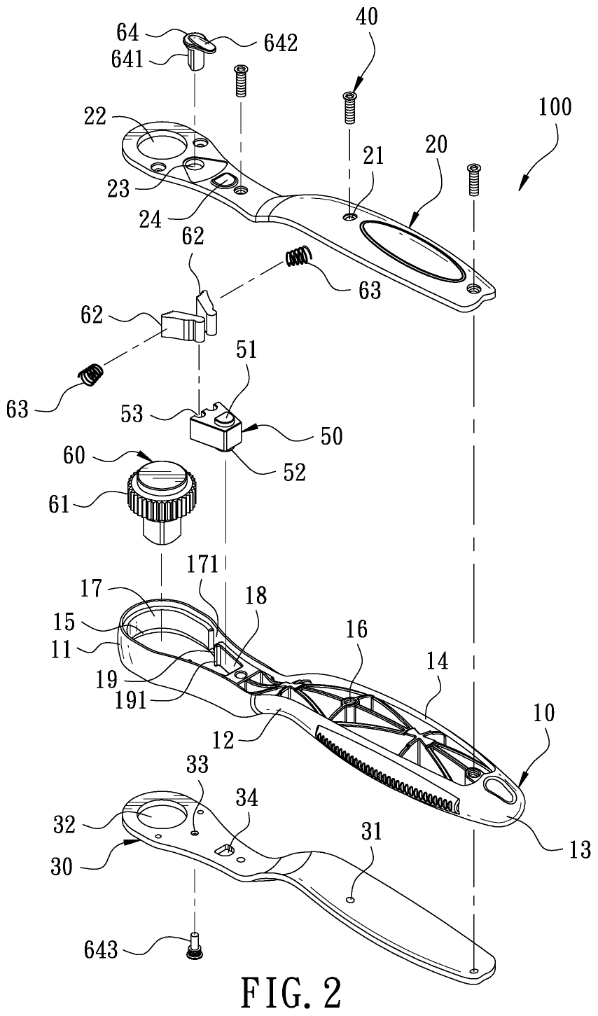

A combined bent handle ratchet wrench 100 in the present invention, as shown in FIGS. 1 and 2, includes a main body 10, a first cover plate 20, a second cover plate 30, a plurality of locking members 40, a positioning seat 50 and a ratchet actuating unit 60 as main components combined together.

The main body 10 made of plastic material, such as engineering plastics, is formed with a head 11 having one side bent upward and extended to form a neck 12, which is parallel to the head 11 and extended to form a handle 13, letting a difference of height formed between the head 11 and the handle 13. Further, the main body 10 has its topside provided with a first shallow recessed groove 14 containing the head 11, the heck 12 and the handle 13 and its underside provided with a second shallow recessed groove 15 corresponding with the first shallow recessed groove 14 and furthermore, the first shallow recessed groove 14 of the main body 10 is bored therein with a plurality of insert holes 16 communicating with the second shallow recessed groove 15.

The first cover plate 20 is made of rigid material, such as iron and formed with a shape corresponding with the first shallow recessed groove 14 and able to be assembled with the first shallow recessed groove 14 for covering the topside of the main body 10. In addition, the first cover plate 20 is bored with a plurality of locking holes 21 corresponding to the insert holes 16.

The second cover plate 30 is made of rigid material, such as iron and formed with a shape corresponding with the second shallow recessed groove 15 and able to be combined with the second shallow recessed groove 15 for covering the underside of the main body 10 and further, the second cover plate 15 is bored with a plurality of locking holes 31 corresponding to the insert holes 16.

The locking members 40 are respectively inserted through the corresponding first locking holes 21, the insert holes 16 and the second locking holes 31 for firmly locking the first cover plate 20 and the second cover plate 30 on the main body 10.

When the combined bent handle ratchet wrench 100 is to be produced and assembled through foresaid structure, engineering plastics, which is easy to be molded, can be employed for producing the main body 10, and iron plates can be easily bent for producing the first cover plate 20 and the second cover plate 30 and then adopt sandwich-like structure to have the main body 10 sandwiched between the first cover plate 20 and the second cover plate 30. Thus, compared with the conventional forging molded bent handle ratchet wrench, the combined bent handle ratchet wrench of this invention can greatly reduce difficulty in production and lower cost and further can maintain a certain strength. Moreover, since a difference of height exists between the head 11 and the handle 13 of the combined bent handle ratchet wrench through the bent neck 12, that is, the head 11 and the handle 13 are not located at the same level; therefore, the combined bent handle ratchet wrench of this invention can be grasped and operated conveniently.

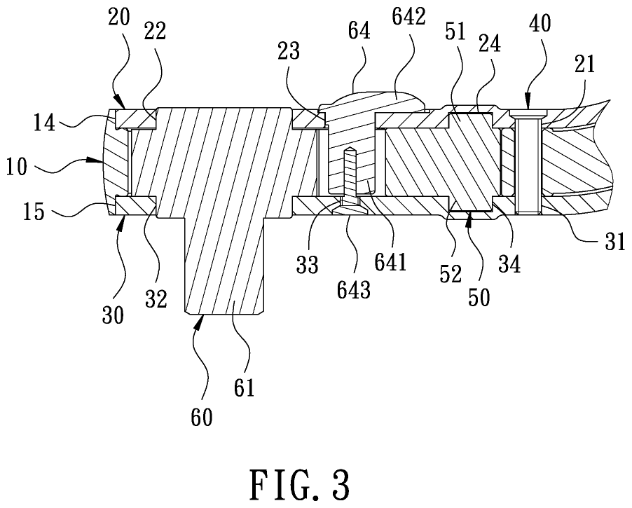

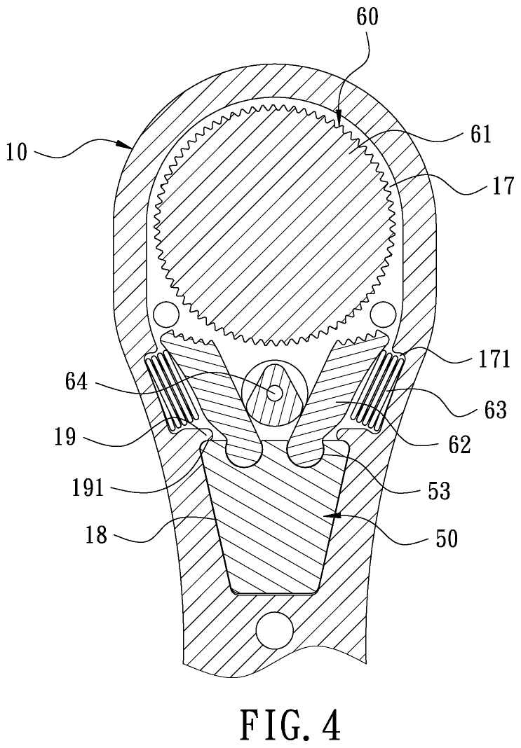

Referring to FIGS. 3 and 4, the combined bent handle ratchet wrench 100 further contains the following structure:

The shallow recessed groove 14 of the main body 10 is provided therein with a first accommodating groove and a second accommodating groove 18 communicating with the second shallow recessed groove 15 at locations corresponding to the head 11. The second accommodating groove 18 is positioned between the first accommodating groove 17 and the neck 12, and a communicating port 19 is disposed between the first accommodating groove 17 and a second accommodating groove 18, letting the first accommodating groove 17 and a second accommodating groove 18 communicating with each other. Further, the main body 10 is symmetrically extended with a pair of position-limiting flanges 191 at the location of the communicating port 19, and the first accommodating groove 17 of the main body 10 has its inner wall symmetrically formed with a pair of notches 171.

The first cover plate 20 is bored with a first pivotal hole 22 and a first operating hole 23 corresponding to the first accommodating groove 17 and has its inner side provided with a first positioning groove 24 corresponding to the second accommodating groove 18.

The second cover plate 30 is bored with a second pivotal hole 32 corresponding with the first pivotal hole and provided with a second operating hole 33 corresponding with the first operating hole 23 and further has its inner side bored with a second positioning groove 34 corresponding with the second accommodating groove 18.

The positioning seat 50 made of rigid material, such as iron, is received in the second accommodating groove 18 and restrictedly positioned in the second accommodating groove 18 by the position-limiting flanges 191. The positioning seat 50 has opposite two sides respectively provided with a first positioning block 51 and second positioning block 52, and the first positioning block 51 is positioned in the first positioning groove 24, while the second positioning block 52 is positioned in the second positioning groove 34. In addition, the positioning seat 50 is symmetrically provided with two pivotal notches 53 at one side facing the communicating port 19.

The ratchet actuating unit 60 has a ratchet member 61 mounted in the first accommodating groove 17. The ratchet member 61 has two ends respectively and rotatably inserted in the first pivotal hole 22 and the second pivotal hole 32 so that the ratchet member 61 can be rotated in the first accommodating groove 17. Further, the ratchet actuating unit 60 contains two engage blocks provided between the ratchet member 61 and the positioning seat 50 and respectively having one end rotatably received in the pivotal notches 53 and another end engaged with the ratchet member 61. Furthermore, the ratchet actuating unit 60 consists of two elastic members 63 respectively received in the notches 171 for respectively pushing against the engage blocks 62 and the inner wall of the first accommodating groove 17. The ratchet actuating unit 60 further includes an operating member 64 having its shank 641 inserted between the two engage blocks 62, and the shank 641 has one end inserted out of the operating hole 23 and forming a turning button 642 and includes a position-limiting member 643, which is inserted through the second operating hole 33 and locked with the shank 641 to have another end of the shank 641 restrictedly positioned in the second operating hole 33.

Based on foresaid structure, the positioning seat 50 is restrictedly positioned in the second accommodating groove 18 and impossible to move freely, and the positioning seat 50 is positioned in the first positioning groove 24 of the first cover plate 20 by the first positioning block 51 and positioned in the second positioning groove 34 of the second cover plate 30 by the second positioning block 52 and further, the positioning seat 50, the first cover plate 20 and the second cover plate 30 are made of rigid materials. Therefore, the combined bent handle ratchet wrench of this invention can greatly enhance the structural strength to enable the ratchet actuating unit 60 to bear greater torsion for ameliorating the conventional combined ratchet wrench that is insufficient in torsion.

While the preferred embodiment of the invention has been described above, it will be recognized and understood that various modifications may be made therein and the appended claims are intended to cover all such modifications that may fall within the spirit and scope of the invention.

What is claimed is:

1. A combined bent handle ratchet wrench comprising:
a main body made of plastic material and formed with a head, said head having one side bent upward and extended to form a neck, said neck being parallel to said head and further extended to form a handle, a difference of height formed between said head and said handle, said main body having a topside provided with a first accommodating groove and a second accommodating groove, said second accommodating groove located between said first accommodating groove and said neck, a communicating port provided between said first accommodating groove and said second accommodating groove, letting said first accommodating groove and said second accommodating groove communicate with each other;
a first cover plate made of rigid material, said first cover plate covered on the topside of said main body, said first cover plate containing said head, said neck and said handle, said first cover plate bored with a first pivotal hole and a first operating hole corresponding to said first accommodating groove, said first cove plate having an inner side provided with a first positioning groove corresponding to said second accommodating groove;
a second cove plate made of rigid material, said second cove plate covered at the underside of said main body and containing said head, said neck and said handle, said second cove plate bored with a second pivotal hole corresponding with said first pivotal hole and provided with a second operating hole corresponding with said first operating hole, said second cover plate having an inner side bored with a second positioning groove corresponding to said first positioning groove;
a positioning seat made of rigid material and received in said second accommodating groove, said positioning seat having opposite two sides a respectively formed with a first positioning block and a second positioning block, said first positioning block positioned in said first positioning groove, said second positioning block positioned in said second positioning groove, said positioning seat symmetrically disposed with two pivotal notches at one side facing said communicating port; and
a ratchet actuating unit formed with a ratchet member received in said first accommodating groove, said ratchet member having two ends respectively and rotatably inserted in said first pivotal hole and said second pivotal hole to enable said ratchet member to rotate in the first accommodating groove, said ratchet actuating unit comprising two engage blocks positioned between said ratchet member and said positioning seat, said engage blocks having their one end rotatably set in said pivotal notches, said engage blocks having another end engaged with said ratchet member, said ratchet actuating unit having two elastic members respectively fixed between said engage block and an inner wall of said first accommodating groove, said ratchet actuating unit further containing an operating member, said operating member having a shank inserted between said engage blocks, said shank of said operating member having one end inserted out of said first operating hole and forming a turning button, said shank having another end restrictedly positioned in said second operating hole.

2. The combined bent handle ratchet wrench as claimed in claim 1, wherein said main body has topside provided with a first shallow recessed groove containing said head, said neck and said handle and said main body has underside disposed with a second shallow recessed groove corresponding with said first shallow recessed groove, said first shallow recessed groove bored with a first accommodating groove and a second accommodating groove communicating with said second shallow recessed groove, said first cover plate forming a shape corresponding to said first shallow recessed groove and covered in said first shallow recessed groove, said second cover plate forming a shape corresponding to said second shallow recessed groove and covered in said second shallow recessed groove.

3. The combined bent handle ratchet wrench as claimed in claim 2, wherein said first shallow recessed groove of said main body is bored with a plurality of insert holes communicating with said second recessed groove, said first cover plate bored with a plurality of first locking holes corresponding to said insert holes, said second cover plate provided with a plurality of second locking holes corresponding to said insert holes, a plurality of locking members respectively inserted through corresponding said first locking hole and said insert hole and said second locking hole to have said first cover plate and said second cover plate firmly locked with said main body.

4. The combined bent handle ratchet wrench as claimed in claim 1, wherein said main body is symmetrically extended to form a pair of position-limiting flanges at a location of said communicating port for restrictedly positioning said positioning seat in said second accommodating groove.

5. The combined bent handle ratchet wrench as claimed in claim 1, wherein said first accommodating groove of said main body has an inner wall symmetrically bored with a pair of notches, said elastic members respectively received in said notches.

6. The combined bent handle ratchet wrench as claimed in claim 1, wherein said plastic material is engineering plastics, and said rigid material is metal.

7. The combined bent handle ratchet wrench as claimed in claim 1, wherein said ratchet actuating unit further comprises a position-limiting member, said position-limiting member inserted through said second operating hole and locked with said shank of said operating member to have another end of said shank restrictedly positioned in said second operating hole.
